(19) United States
(12) Patent Application Publication
(10) Pub. No.: US 2012/0049132 A1
(43) Pub. Date: Mar. 1, 2012

(54) FUSED CERMET PRODUCT

(75) Inventors: Samuel Marlin, Plan d'Orgon (FR); Victor Manuel Orera Clemente, Zaragoza (ES); Jose Ignacio Pena Torre, Zaragoza (ES); Luis Ortega San Martin, Basauri (ES)

(73) Assignee: CONSEJO SUPERIOR DE INVESTIGACIONES CIENTIFICAS, Madrid (ES)

(21) Appl. No.: 13/255,807

(22) PCT Filed: Mar. 12, 2010
(86) PCT No.: PCT/IB2010/051086

§ 371 Date: Nov. 10, 2011

(30) Foreign Application Priority Data
Mar. 12, 2009 (FR) 0901159

(51) Int. Cl. H01B 1/02; H05B 6/00; C04B 35/50

(52) U.S. Cl. 252/513; 264/618; 264/434

(57) ABSTRACT

A molten cermet material including a molten cermet of cerium oxide CeO₂, optionally doped, and nickel Ni and/or cobalt Co, the cermet having a eutectic structure, the cerium oxide, nickel, and cobalt contents being in mol %: 0.351 Ni+0.136 Co≦(CeO₂+dopant)≦0.538 Ni+0.282 Co.

### TECHNICAL FIELD

This disclosure generally relates to a fused cermet product, in particular for manufacturing an element of a solid-oxide fuel cell (SOFC) stack and especially an anode of such a cell stack. The disclosure also relates to a fused cermet precursor and to processes for manufacturing said fused cermet product and said cermet precursor.

### BACKGROUND

FIG. 1 shows schematically in cross section an example of a solid-oxide fuel cell (SOFC) stack 10, manufactured by a hot pressing operation. The stack 10 comprises first and second elementary cells 12 and 14 respectively, which are separated by an interconnector layer 16. Since the first and second elementary cells are of similar structure, only the first elementary cell 12 is described. The first elementary cell 12 comprises, in succession, an anode 18, an electrolyte layer 20 and a cathode 22. The anode 18 consists of an anode functional layer (AFL) 24, in contact with the electrolyte layer 20, and an anode support layer 26. The anode 18 is generally manufactured by a process consisting in depositing an anode functional layer 24 on the anode support layer 26, for example by screen printing. At this stage, the layers 24 and 26 may be based on a precursor of the final anode material. A sintering consolidation step is then carried out.

Fuel cell stacks or materials that can be used for manufacturing fuel cell stacks are for example described in WO 2004/093235, EP 1 796 191, US 2007/0082254, EP 1 598 892 or EP 0 568 281.

Porous cermets based on yttria-stabilized zirconia and nickel (Ni-YSZ) are widely used to manufacture the anode functional layer. These cermets have in particular been studied in the articles entitled “Stability of Channeled Ni-YSZ Cermets Produced from Self assembled NiO-YSZ Directionally Solidified Eutectics”, in J. Am. Ceram. Soc., 88, 3215-3217 (2005) and “Structured porous Ni- and Co-YSZ cermets fabricated from directionally solidified eutectic composites”, in Journal of the European Ceramic Society 25, 1455-1462 (2005). These articles describe especially processes for manufacturing an ionically and electronically conducting porous lamellar structure that may be used to manufacture an anode of a solid-oxide fuel cell.

The article “Directionally solidified calcia stabilised zirconia-nickel oxide plates in anode supported solid oxide fuel cells” in Journal of the European Ceramic Society, 24, 1349-1353 (2004) also describes cermets based on calcia-stabilized zirconia and nickel (Ni—CaSZ).

Moreover, the article “CeO₂—CoO Phase Diagram” in J. Am. Ceram. Soc., 86, 1567-1570 discloses a 20 mol % CeO₂/80 mol % CoO compound having an irregular eutectic structure. The cooling rate during solidification, or “solidification rate”, is 10° C./min, i.e. 0.16 K/s. According to that document, a eutectic structure is possible for CoO contents of 82±1.5 mol %.

To optimize the operation of the anode functional layer, there is a need for a porous material capable of substantially retaining its properties, in particular its porosity, as it ages, for example after having been subjected for 300 hours to a temperature of 750° C.

The objective of the embodiments of the present disclosure is to satisfy this need.

### SUMMARY

In embodiments, the above objective is achieved by means of a fused cermet product comprising a fused cermet based on possibly doped cerium oxide CeO₂, nickel Ni and/or cobalt Co, said cermet having a eutectic structure and the percentage molar contents of cerium oxide, possible dopant, nickel and cobalt being such that:

0.351 Ni+0.136 Co≦(CeO₂+dopant)≦0.538 Ni+0.282 Co.

As will be seen in greater detail in the rest of the description, this cermet, called “cermet according to the invention”, advantageously has properties that make it suitable for application in SOFC stacks, in particular in an anode functional layer.

The balance to 100% of a cermet product according to the invention preferably consists of impurities and nickel oxide and/or cobalt oxide, preferably in proportions such that: 0.351 NiO+0.136 CoO≦(CeO₂+dopant)≦0.538 NiO+0.282 CoO. Preferably, when the cermet does not contain Ni, the balance to 100% does not contain NiO. Preferably, when the cermet does not contain Co, the balance to 100% does not contain CoO.

In embodiments, a cermet according to the invention represents mare than 50%, more than 70%, more than 90%, more than 95%, more than 98% or even substantially 100% of the mass of a cermet product according to the invention.

A cermet according to the invention may further comprise one or more of the following optional features (to the extent that they are not incompatible):

0.370 Ni+0.176 Co≦(CeO₂+dopant)≦0.493 Ni+0.250 Co;

0.399 Ni+0.198 Co≦(CeO₂+dopant)≦0.460 Ni+0.227 Ca;
the cermet comprises less than 1% nickel, and preferably contains no nickel;

0.136 Co≦(CeO₂+dopant)≦0.282 Co;
for a total, excluding impurities, of 100%:
   (CeO₂+dopant): 12%-22%
   Co; 78%-88%;
for a total, excluding impurities, of 100%:
   (CeO₂+dopant): 15%-20%
   Co: 80%-85%;
for a total, excluding impurities, of 100%:
   (CeO₂+dopant): 16.5%-18.5%
   Co: 81.5%-83.5%;
the cermet has the following composition:
   (CeO₂+dopant): 17.5%-18.2%
   Co: 81.8%-82.5%;
the cermet has the following composition:
   (CeO₂+dopant): 18%
   Co: 82%;
the cermet comprises less than 1% cobalt and preferably contains no cobalt;

0.351 Ni≦(CeO₂+dopant)≦0.538 Ni;
for a total, excluding impurities, of 100%:
   (CeO₂+dopant): 26%-35%
   Ni: 65%-74%;
for a total, excluding impurities, of 100%:
   (CeO₂+dopant): 27%-33%
   Ni: 67%-73%;
for a total, excluding impurities, of 100%:
   (CeO₂+dopant): 28.5%-31.5%
   Ni: 68.5%-71.5%;
the cermet has the following composition:
   (CeO₂+dopant): 30.2%
   Ni: 69.8%;
the cerium oxide CeO₂ is not doped or is doped with an element selected from the lanthanides (the elements of the periodic table having an atomic number between 57 and 71), with the exception of cerium, and mixtures thereof, yttrium, magnesium, calcium, strontium, barium, preferably selected from samarium and/or gadolinium;
in one embodiment, the dopant is chosen from the lanthanides, with the exception of cerium and samarium;
the dopant molar content of the cerium oxide CeO₂, on the basis of the sum of the contents of cerium cations and dopant cations, is greater than 8% and/or less than 25%;
more than 90%, more than 95% or even substantially 100%, as molar percentages, of the cerium oxide CeO₂ is doped, preferably with samarium and/or gadolinium;
the cerium oxide CeO₂ is doped only with samarium;
the samarium molar content, on the basis of the sum of the cerium and samarium molar contents, is greater than 16% and/or less than 24%, preferably substantially equal to 20%;
the cerium oxide CeO₂ is doped only with gadolinium;
the gadolinium molar content, on the basis of the sum of the cerium and gadolinium molar contents, is greater than 8% and/or less than 14%, preferably substantially equal to 10%;
cerium oxide, nickel, cobalt, samarium and gadolinium represent more than 95%, more than 98%, more than 99% or even substantially 100%, as molar percentages, of the cermet. Preferably, the balance to 100% consists of impurities;
the cermet has a total porosity, preferably uniformly distributed, of greater than 20%, preferably greater than 25% or even greater than 30% or 40%, and even reaching 50%;
the cermet has an open porosity of between 25% and 60%, preferably between 30% and 45%, preferably between 30% and 40%; and
the cermet has an impurity content of less than 5%, preferably less than 2%, and even more preferably less than 1% by weight.

Embodiments of the present disclosure also relate to an electrode, in particular to an anode, having a region, in particular a functional anode, said anode and/or said functional anode being formed from a powder of particles made of a fused cermet product according to the invention. The invention also relates to an elementary cell of a solid-oxide fuel cell stack comprising an anode according to the present disclosure, and to such a fuel cell stack.

Another embodiment also relates to a fused cermet precursor, the composition of which is adapted so as to result, by reduction, in a cermet product according to the invention, with the exclusion of a CeO₂/CoO cermet precursor having an irregular eutectic structure.

Yet another embodiment relates especially to a doped CeO₂/CoO fused cermet precursor, to a CeO₂/NiO fused cermet precursor, this CeO₂ being optionally doped, and to a CeO₂/CoO fused cermet precursor having a lamellar and/or fibrous eutectic structure.

The present disclosure further relates in particular to a fused cermet precursor comprising possibly doped cerium oxide CeO₂, less than 5% by weight of impurities and, as balance to 100%, nickel oxide NiO and/or cobalt oxide CoO, the percentage molar contents of cerium oxide, nickel oxide and cobalt oxide being such that:

0.351 NiO+0.136 CoO≦(CeO₂+dopant)≦0.538 NiO+0.282 CoO.

This cermet precursor makes it possible to manufacture, by means of a reduction operation, a fused cermet product according to the invention. In particular, a cermet precursor according to the invention may have one or more of the following optional features:

0.370 NiO+0.176 CoO≦(CeO₂+dopant)≦0.493 NiO+0.250 CoO;

0.399 NiO+0.198 CoO≦(CeO₂+dopant)≦0.460 NiO+0.227 CoO;
the cermet precursor contains no nickel;

0.136 CoO≦(CeO₂+dopant)≦0.282 CoO;
for a total, excluding impurities, of 100%:
   (CeO₂+dopant): 12%-22%
   CoO: 78%-88%;
for a total, excluding impurities, of 100%:
   (CeO₂+dopant): 15%-20%
   CoO: 80%-85%;
for a total, excluding impurities, of 100%:
   (CeO₂+dopant): 16.5%-18.5%
   CoO: 81.5%-83.5%;
the cermet precursor has the following molar composition:
   (CeO₂+dopant): 17.5%-18.2%
   CoO: 81.8%-82.5%;
the cermet precursor has the following molar composition:
   (CeO₂+dopant): 18%
   CoO: 82%;
the cermet precursor contains no cobalt;

0.351 NiO≦(CeO₂+dopant)≦0.538 NiO;
for a total, excluding impurities, of 100%:
   (CeO₂+dopant): 26%-35%
   NiO: 65%-74%;
for a total, excluding impurities, of 100%:
   (CeO₂+dopant): 27%-33%
   NiO: 67%-73%;
for a total, excluding impurities, of 100%:
   (CeO₂+dopant): 28.5%-31.5%
   NiO: 68.5%-71.5%;
the cermet precursor has the following molar composition, corresponding to the eutectic:
   (CeO₂+dopant): 30.2%
   NiO: 69.8%;
the cerium oxide CeO₂ is not doped or is doped with an element selected from the lanthanides (the elements of the periodic table having an atomic number between 57 and 71), with the exception of cerium, and mixtures thereof, yttrium, magnesium, calcium, strontium, barium, preferably selected from samarium and/or gadolinium;
the dopant molar content of the cerium oxide CeO₂, on the basis of the sum of the contents of cerium cations and dopant cations, is greater than 8% and/or less than 25%;
more than 90%, more than 95% or even substantially 100%, as molar percentages, of the cerium oxide CeO₂ is doped, preferably with samarium and/or gadolinium;
the cerium oxide CeO₂ is doped only with samarium;
the samarium molar content, on the basis of the sum of the cerium and samarium molar contents, is greater than 16% and/or less than 24%, preferably substantially equal to 20%;
the cerium oxide CeO₂ is doped only with gadolinium;
the gadolinium molar content, on the basis of the sum of the cerium and gadolinium molar contents, is greater than 8% and/or less than 14%, preferably substantially equal to 10%;
cerium oxide, nickel oxide, cobalt oxide, samarium and gadolinium represent more than 95%, more than 98%, more than 99% or even substantially 100%, as molar percentages, of the cermet precursor; and
the cermet precursor has an impurity content of less than 5%, preferably less than 2%, even more preferably less than 1% by weight.

A cermet or a cermet precursor according to the invention may also comprise one or more of the following optional features:
it has a lamellar and/or fibrous structure; in the lamellar structure, the mean spacing between two lamellae may in particular be greater than 0.2 μm, preferably greater than 0.3 μm, and/or less than 6 μm, preferably less than 4 μm;
it takes the form of a fused bead, a particle powder, a fused plate, a fused block, or a particle resulting from milling such a fused plate or such a fused block;
it takes the form of a powder that can be sintered, a preform or a “green” part obtained from such a powder, or a sintered product obtained from such a preform, in particular a sintered part or layer. The preform or the sintered product may in particular take the form of a layer having a thickness of less than 2 mm, less than 1 mm or less than 500 μm;
it takes the form of a sintered product having a total porosity of greater than 20%, preferably between 25% and 50% by volume and preferably between 27% and 45%, more preferably still between 30% and 40% by volume.

Another embodiment relates to a manufacturing process comprising the following successive steps:
a) particulate raw materials providing CeO₂, CoO and/or NiO, and/or one or more precursors of these oxides and/or optionally one or more dopants for cerium oxide and/or one or more precursors of these dopants are mixed to form a feedstock;
b) the feedstock is melted so as to obtain a molten material;
c) said molten material is cooled until it has completely solidified so as to obtain a fused product having a eutectic structure;
d) optionally, said fused product is milled;
e) optionally, the fused product, possibly milled, is formed or even sintered; and
f) optionally, the fused product, possibly milled and/or formed and/or sintered, is reduced so as to increase the amount of CoO and/or NiO converted to Co and/or Ni,
   the raw materials being chosen so that, after step c), the fused product obtained comprises a fused cermet product according to the invention, the cooling in step c) consisting in bringing the molten material and/or the fused product into contact with a reducing fluid.

Preferably, the furnace used in step b) is chosen from an induction furnace, a plasma torch, an arc furnace or a laser.

Again preferably, the reduction in step f) takes place simultaneously with sintering.

### DEFINITIONS

The term “cermet” conventionally means a composite material containing both a ceramic phase and a metallic phase. For the sake of clarity, a distinction is made here between the “cermet product” and the “cermet”, the cermet product comprising cermet and possibly other compounds, especially oxides of Ni or Co that have not been reduced.

A product is conventionally referred to as “fused” when it is obtained by a process involving melting of raw materials and solidification by cooling.

The term “eutectic” conventionally refers to a structure or morphology obtained by melting a eutectic composition followed by solidification of the molten material by cooling. The chapter “Solidification microstructure: Eutectic and peritectic” in the document “Fundamentals of Solidification”, third edition, by W. Kurz and D. J. Fisher, Trans. Tech. Publications Ltd, Switzerland (1989), describes the eutectic structures.

To the knowledge of the inventors, a melting step is essential for obtaining a eutectic structure. In particular, the process described in the article “Synthesis and performances of Ni-SDC cermets for IT-SOFC anode” Database Compendex Engineering Information Inc., New York, US by M. Chen et al. describes a process for manufacturing a cermet by the “combustion of urea” that does not result in a eutectic structure.

To obtain a eutectic structure it is also necessary to use a eutectic composition. Such a composition exists only for certain combinations of oxides and, when it does exist, the proportions of the oxides depend on the oxides in question. Even if two eutectic compositions have one oxide in common, the content of the other oxide possibly enabling a eutectic composition to be obtained depends on the nature of this other oxide. For example, the MgO—ZrO₂ and SrO—ZrO₂ eutectic compositions are such that MgO/ZrO₂ is different from SrO/ZrO₂.

Thus, if a document describes a eutectic composition of two oxides and it is envisaged changing one of these oxides, there can be no assurance that a eutectic composition with the new oxide still exists, and even less is it possible to determine a priori the proportions that would enable such a eutectic composition to be obtained.

A eutectic structure of a cermet precursor according to the invention may be of two types: regular (normal) or irregular (abnormal).

The regular structure of a cermet precursor according to the invention has two growth morphologies: lamellar or fibrous, in which there is a clear crystallographic relationship between the phases of the eutectic.

The lamellar morphology corresponds to a stacking of platelets, alternately made of cerium oxide and of cobalt or nickel oxide. As the lamellae solidify, the growth front D₁ (FIG. 6B) moves in the plane of the lamellae. A lamellar structure may in particular result from a process for the manufacture by melting of a eutectic mixture that includes a solidification step at a solidification rate of greater than 20 K/s. Lower rates, for example 10K/s, may also lead to lamellar structures, but checks are then necessary to confirm this.

The fibrous morphology corresponds to a morphology in which one of the phases in the form of fibers is embedded in a continuous matrix formed by the second phase. The axis of the fibers is then parallel to the direction of propagation of the growth front D_{f} (FIG. 6A). A fibrous structure may especially result from a process for the manufacture by melting of a eutectic mixture that includes a solidification step with a solidification rate of less than 20 K/s, less than 10 K/s or less than 5 K/s. However, depending on the composition, a structure corresponding to a mixture of lamellar and fibrous morphologies may also be obtained with a solidification rate of less than 20 K/s.

A solidification rate of greater than 1 K/s is preferable for obtaining a regular eutectic structure. This is because the inventors have found that a solidification rate of less than 1 K/s is conducive to sublimation of the oxide having the lower melting point (CoO and/or NiO), this sublimation possibly generating a noneutectic phase (CeO₂) and thus promoting an irregular eutectic structure. This observation is consistent with the teaching of the article “CeO₂-CoO Phase Diagram” in J. Am. Ceram. Soc. 86, 1567-1570.

In the irregular eutectic structure there is no relationship between the orientation of the two phases, although the fibers generally grow along the propagation direction of the growth front of the eutectic (FIGS. 6C and 6D).

By extension, the term “eutectic structure” also means the structure of a material resulting from the reduction of a cermet precursor having a eutectic structure.

A “dopant” is a metal cation other than the cerium cation, which is incorporated within the CeO₂ crystal lattice, usually in solid solution, namely metal cations present as insertion and/or substitution cations within the cerium oxide.

When cerium oxide CeO₂ is said to be “doped to x % with a dopant”, this conventionally means that, in said doped cerium oxide, the amount of dopant is the molar percentage of dopant cations on the basis of the total amount of dopant cations and cerium cations. For example, in a cerium oxide doped to 10 mol % with gadolinium (Gd), 10 mol % of cerium cations are replaced with gadolinium cations. Such a cerium oxide doped to 10 mol % with Gd is in general described by the formula Ce_{0.9}Gd_{0.1}O_{1.95}. Likewise, in a cerium oxide doped to 20 mol % with samarium (Sm), 20 mol % of the cerium cations are replaced with samarium cations. Such a cerium oxide doped to 20 mol % with Sm is generally described by the formula Ce_{0.8}Sm_{0.2}O_{1.9}.

The expression “(CeO₂+dopant)” is understood to mean the sum of the cerium cation and dopant molar contents.

A precursor based on CeO₂, CoO, NiO or dopant is a compound capable of resulting in the formation of these oxides, respectively, by a process comprising melting followed by solidification by cooling.

A precursor of a cermet product is a material capable, under reducing conditions, of resulting in a cermet product according to the invention.

The expression “size of a particle” is understood to mean the size of a particle conventionally given by particle size distribution characterization using a laser particle size analyzer. The laser particle size analyzer used here is a PARTICA® LA-950 instrument from the company HORIBA®.

The term “impurities” is understood to mean the inevitable constituents introduced, unintentionally and unavoidably, with the raw materials or resulting from reactions with these constituents. The impurities are not necessary constituents but merely tolerated. For example, the compounds forming part of the group of oxides, nitrides, oxynitrides, carbides, oxycarbides, carbonitrides and metallic species of sodium and other alkali metals, iron, vanadium and chromium are impurities if their presence is not desired.

By “Co” and “Ni” is meant metallic cobalt and metallic nickel.

Unless otherwise indicated, all the percentages are molar percentages.

### BRIEF DESCRIPTION OF THE DRAWINGS

Other features and advantages of the invention will become more clearly apparent on reading the following description and on examining the appended drawings in which:

FIG. 1 shows schematically, in cross section, a solid-oxide fuel cell (SOFC) stack according to the present disclosure.

FIGS. 2A-2F, 3A-3F, 4A-4D and 5 show micrographs of: cermet precursors according to the invention CeO₂—CoO (FIGS. 2A to 2F) and 10 mol % Gd₂O₃-doped CeO₂—CoO (FIGS. 3A to 3F); cermets according to the invention 10 mol % Gd₂O₃-doped CeO₂—CoO (FIGS. 4A to 4D) after a reduction treatment at 750° C.; and a cermet precursor according to the invention CeO₂—NiO (FIG. 5), these micrographs being taken by SEM (Scanning Electron Microscopy). In the cermet precursor micrographs, the magnification and the solidification rate “v” are indicated. In FIGS. 2A to 2F and 3A to 3F, the cerium oxide CeO₂ appears white and the cobalt oxide CoO appears gray. In FIGS. 4A to 4D, the cerium oxide CeO₂ appears white, the cobalt Co appears gray and the pores appear black. In FIG. 5, the cerium oxide CeO₂ appears white and the nickel oxide NiO appears dark gray.

FIGS. 6A to 6D show diagrams illustrating regular eutectic morphologies (FIGS. 6A and 6B) and irregular eutectic morphologies (FIGS. 6C and 6D).

FIGS. 7A and 7B show diagrams illustrating the reduction treatment carried out for the examples.

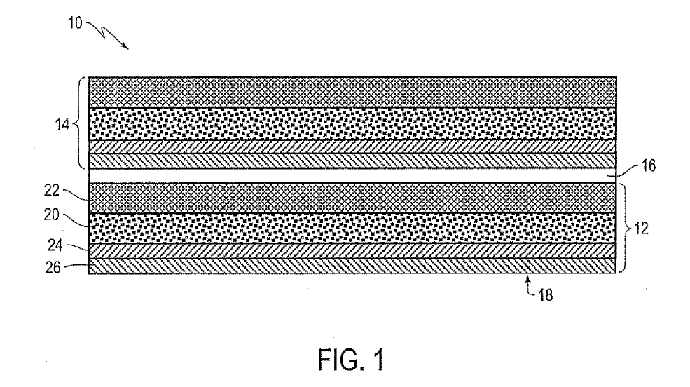

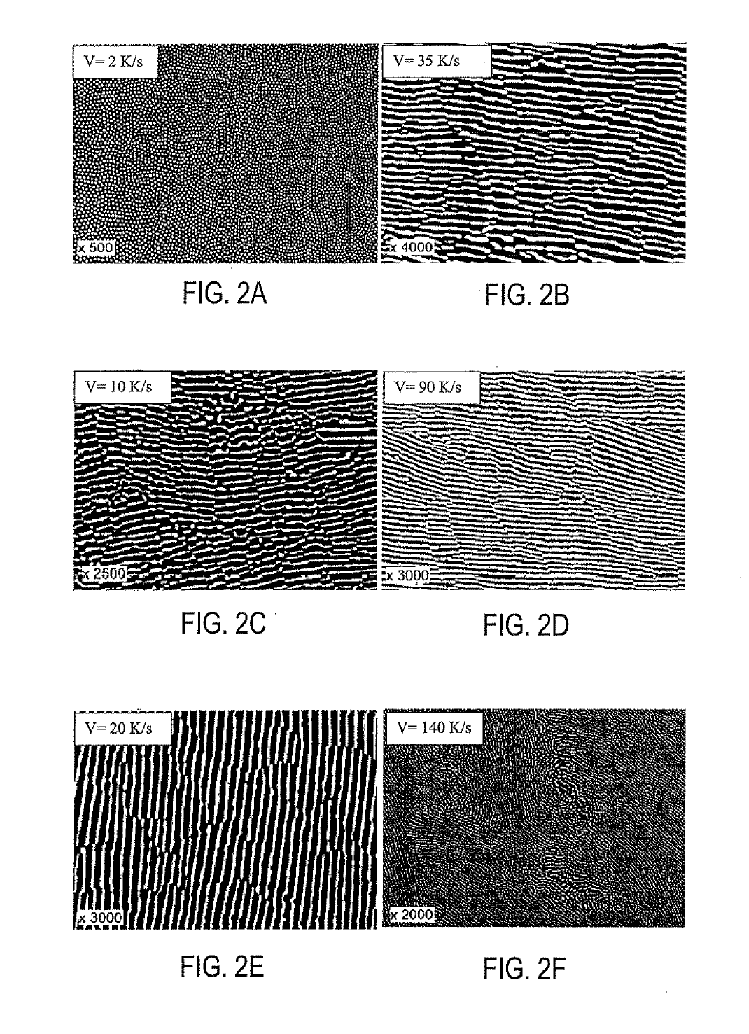

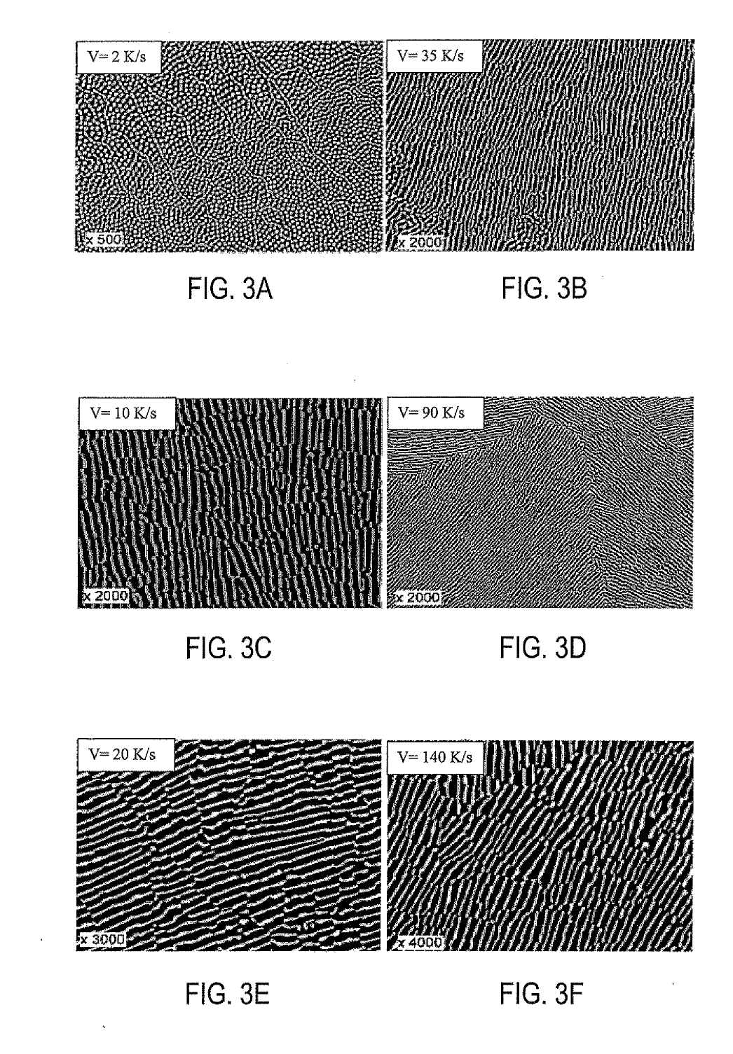

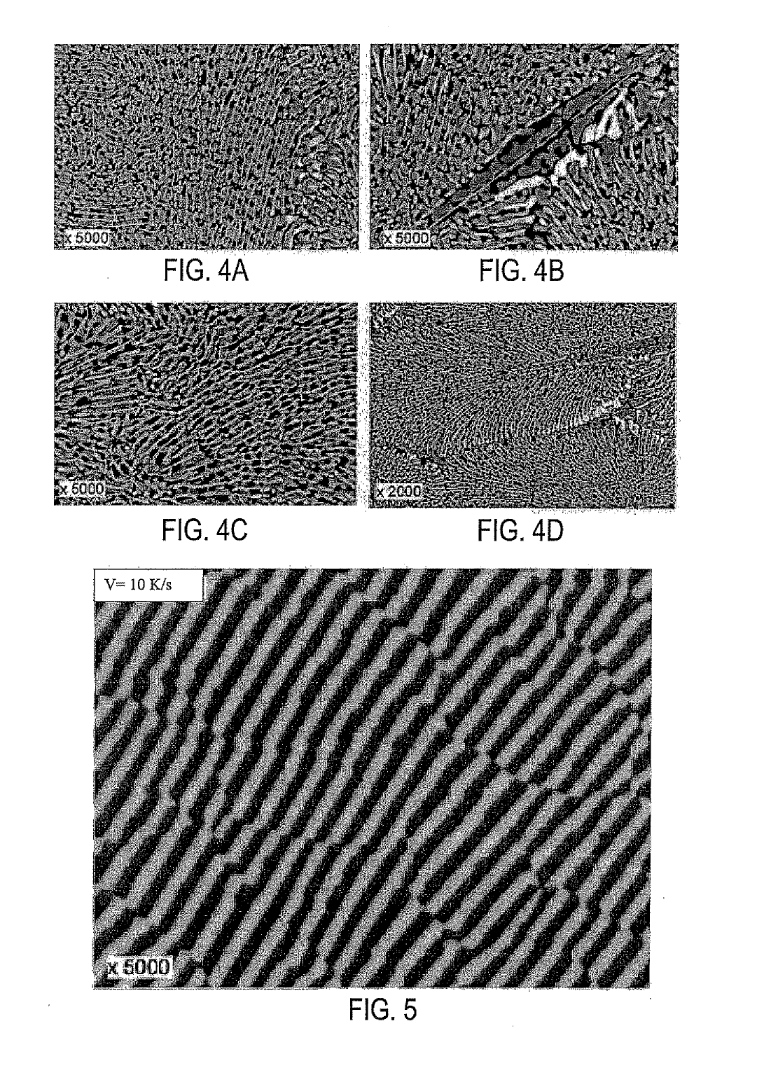

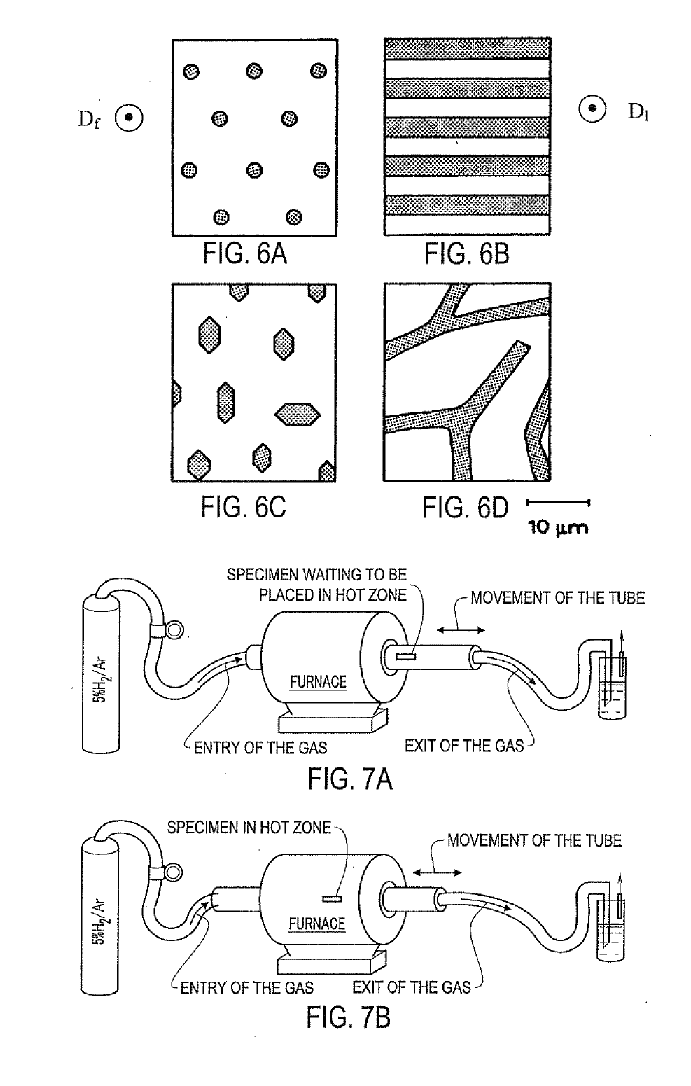

The changes of orientation in the direction of the lamellae that may be seen in the various figures are due to the changes in direction of the eutectic growth plane front.

### DETAILED DESCRIPTION OF EMBODIMENTS

Embodiments of the present disclosure relate to a general process for manufacturing a cermet precursor according to the invention or a fused cermet product according to the invention, comprising the following successive steps:
a) particulate raw materials providing CeO₂, CoO and/or NiO, and/or one or more of the precursors of these oxides and/or optionally one or more dopants for cerium oxide and/or one or more precursors of these dopants are mixed to form a feedstock;
b) the feedstock is melted so as to obtain a molten material;
c) said molten material is cooled until it has completely solidified so as to obtain a fused product having a eutectic structure;
d) optionally, said fused product is milled;
e) optionally, the possibly milled, fused product is formed or even sintered; and
f) optionally, the fused product, possibly milled and/or formed or sintered,
   is reduced so as to increase the amount of CoO and/or NiO converted to Co and/or Ni, the raw materials being chosen so that, after step c), the fused product obtained is either:
a fused cermet precursor according to the invention and, in particular, such that it has a composition whereby:

0.351 NiO+0.136 CoO≦(CeO₂+dopant)≦0.538 NiO+0.282 CoO;
the contents being expressed as molar percentages on the basis of the total molar quantity of the oxides CeO₂, CoO and NiO, or
a fused cermet product according to the invention and, in particular, such that it has a composition such that:

0.351 Ni+0.136 Co≦(CeO₂+dopant)≦0.538 Ni+0.282 Co,
the contents being expressed as molar percentages on the basis of the total molar quantity of cerium oxide, possible dopant, nickel and cobalt.

Conventional melting processes thus make it possible to manufacture fused cermet precursors or cermet products of various sizes, for example in the form of particles or blocks. The nature of the product obtained (cermet precursor or cermet product) depends on the oxidation-reduction conditions encountered during implementation of the manufacturing process. In particular, a step f) increases the amount of cermet product.

In step a), the feedstock may be adapted so that the process results, after step c), d) or e), in a cermet precursor according to the invention possibly having one or more of the optional features described above.

The oxides CeO₂, CoO and/or NiO, their precursors, the dopants of the cerium oxide and their precursors preferably constitute, with the impurities, 100% of the oxides of the feedstock. Preferably, the impurities are such that, in molar percentages on the basis of the oxides of the feedstock:
ZrO₂<0.5%; and/or
Na₂O<0.3%; and/or
Fe₂O₃<0.2%; and/or
Al₂O₃<0.3%; and/or
except when CaO is intentionally added as dopant for the cerium oxide, CaO<0.2%; and/or
except when MgO is intentionally added as dopant for the cerium oxide, MgO<0.2%.

In one embodiment, the feedstock does not comprise urea.

In step b), an induction furnace, a plasma torch, an arc furnace or a laser may especially be used. Preferably, an arc furnace or an induction furnace is used. Advantageously, it is thus possible to obtain large amounts of product on an industrial scale.

In step b), the melting is preferably carried out under oxidizing conditions. The oxidizing conditions in step b) may be maintained in step c).

Step c) may be carried out, completely or partially, under oxidizing conditions or under reducing conditions. Under oxidizing conditions, a step f) is necessary in order to obtain a cermet product according to the invention. Under reducing conditions, a step f) may advantageously be optional.

In step c), the solidification rate determines the structure and, in particular in the case of a lamellar structure, the mean spacing between two lamellae of the cermet precursor or of the cermet according to the invention manufactured.

The solidification rate may be adapted so as to manufacture cermets in accordance with the present disclosure with a regular eutectic structure. In particular, it may preferably be greater than 1 K/s.

If a lamellar structure is desired, the solidification rate is preferably greater than 20 K/s. If a fibrous structure is desired, the solidification rate is preferably less than 20 K/s, preferably less than 10 K is, preferably less than 5 K/s.

In optional step d), the fused product obtained after step c) may be milled so as to make the subsequent steps easier. The particle size of the milled product is adapted according to its use. Where appropriate, the milled particles undergo a particle size selection operation, for example a screening operation.

The milled, and possibly screened, particles may especially have a size of greater than 0.1 μm, or even greater than 1 μm, or even greater than 0.3 μm, or even greater than 0.5 μm, or even greater than 1 μm, or even greater than 15 μm, or even greater than 20 μm and/or less than 6 mm, or even less than 4 mm, or even less than 3 mm, or even less than 70 μm, or even less than 50 μm.

In optional step e), the product is formed, especially so as to be sintered. All conventional forming and sintering techniques may be used.

In one particular embodiment, the sintering is carried out in situ, that is to say after the fused, and possibly milled, product has been placed in its service position, for example in the form of an anode layer.

In step f), the reduction results in at least some of the NiO and CoO oxides being converted to Ni and Co respectively. For this purpose, the cermet precursor according to the invention resulting from step c), d), or e) is exposed to a reducing environment. For example, it may be brought into contact with a reducing fluid such as a hydrogen-containing gas.

Said reducing fluid preferably comprises at least 5%, preferably at least 20% and even at least 50% hydrogen (H₂) by volume.

In one particular embodiment, step f) is partly carried out simultaneously with step e), the reduction being carried out simultaneously with sintering. In other words, the sintering is carried out in a reducing environment. Advantageously, the efficiency of the process is thereby considerably improved.

After step f), a powder of a cermet product according to the invention is obtained.

Preferably, the process comprises neither an auto-ignition step nor a self-sustained combustion step, in particular of the type described in the article “Synthesis and performances of Ni-SDC cermets for IT-SOFC anode” mentioned above.

A cermet product according to the invention may have a high total porosity, typically greater than 20% and/or less than 60%. The porosity of the cermet is of great importance since the pores are the site of some of the catalysis reactions necessary for operation of the fuel cell. The pores are also the means for conveying gas into the anode. When the porosity is stable over time, it is possible to limit the deterioration in the performance of the fuel cell while being used.

Another embodiment relates to a first particular manufacturing process comprising steps a) and b) described above in the context of the general manufacturing process and denoted, for this first process, by “a₁)” and “b₁)” respectively, and a step c) comprising the following steps:
c₁′) dispersion of the molten material in the form of liquid droplets; and
c₁″) solidification of these liquid droplets by contact with a fluid, so as to obtain fused cermet precursor particles.

By simple adaptation of the feedstock composition, conventional dispersion processes, for example blowing, centrifugation or atomization, thus make it possible to manufacture particles of a cermet precursor according to the invention from a molten material.

A first particular manufacturing process may also have one or even several of the optional features of the general manufacturing process that are listed above.

In step c₁′) and/or in step c₁″), said molten material and/or said liquid droplets undergoing solidification may be brought into contact with an oxidizing fluid. If during these steps neither said molten material nor said liquid droplets undergoing solidification have been in contact with a reducing fluid, a step f) is essential for obtaining a cermet product according to the invention.

After step c), beads of the present disclosure, made of a cermet precursor according to the invention, are therefore obtained.

In one particularly advantageous variant, in step c₁′) and/or step c₁″), said molten material and/or said liquid droplets undergoing solidification are brought into contact with a reducing fluid, this being preferably identical for step c₁′) and step c₁″). Advantageously, step f) is consequently no longer essential for obtaining a cermet product according to the invention. The reducing fluid may comprise at least 5%, preferably at least 20% or even at least 50% hydrogen (H₂) by volume.

Even when a reducing fluid is used in step c₁′) and/or in step c₁″), a step f) may be envisaged for increasing the amount of cermet. The preferably gaseous reducing fluid used in step c₁′) and/or step c₁″) may then be the same as or different from that possibly used in step f).

In one embodiment, the dispersion step c₁′) and the solidification step c₁″) are substantially simultaneous, the means employed for the dispersion causing the molten material to cool. For example, the dispersion results from blowing gas through the molten material, the temperature of said gas being adapted to the desired solidification rate.

The time during which the droplets are in contact with the oxidizing or reducing fluid may vary. However, it is preferable to maintain contact between the droplets and this fluid until said droplets have completely solidified.

Embodiments of the present disclosure also relate to a second particular manufacturing process comprising steps a) and b) described above in the context of the general manufacturing process and denoted, for this second particular manufacturing process, by “a₂)” and “b₂)” respectively, and a step c) comprising the following steps:
c₂′) casting of said molten material in a mold;
c₂″) solidification of the cast material by cooling in the mold until an at least partly or even completely solidified block is obtained; and
c₂′″) demolding of the block.

This second particular manufacturing process may further include one or even several of the optional features of the general manufacturing process listed above.

In one particular embodiment, in step c₂′) a mold allowing rapid cooling is used. In particular, it is advantageous to use a mold capable of forming a block in the form of a sheet and preferably a mold as described in U.S. Pat. No. 3,993,119.

In step c₂′) and/or step c₂″) and/or step c₂′″) and/or after step c₂′″), said molten material and/or the cast material undergoing solidification in the mold and/or the demolded block may be brought into contact with an oxidizing fluid. If during these steps neither said molten material, nor the cast material undergoing solidification in the mold, nor the demolded block have been in contact with a reducing fluid, a step f) is essential for obtaining a cermet product according to the invention.

In an advantageous variant, in step c₂′) and/or step c₂″) and/or step c₂′″) and/or after step c₂′″), said molten material during casting and/or during solidification and/or the demolded block may be brought, directly or indirectly, into contact with a reducing fluid. The reducing fluid may comprise at least 5%, preferably at least 20% and even at least 50% hydrogen (H₂) by volume. Contacting with a reducing fluid is particularly effective when the mold is designed to manufacture a block with a thickness of less than 10 mm, or even less than 5 mm, especially in the form of a plate.

The preferably gaseous reducing fluid used in step c₂′) and/or step c₂″) and/or step c₂′″) and/or after step c₂′″) may be the same as or different from that possibly used in step f).

Even when a reducing fluid is used in step c₂′) and/or c₂″) and/or step c₂′″) and/or after step c₂′″), a step f) is generally preferable for increasing the amount of cermet, especially during manufacture of a bulk block. The preferably gaseous reducing fluid used in step c₂′) and/or step c₂″) and/or step c₂′″) and/or after step c₂′″) may then be the same as or different from that possibly used in step f).

Preferably, said contacting with the oxidizing fluid or the reducing fluid starts right from the casting of the molten material in the mold and stops with the demolding of the block. Also preferably, said contacting is maintained until the block has completely solidified.

In step c₂″), the solidification rate of the molten material during cooling may especially be always less than 1000 K/s, less than 100 K/s, less than 50 K/s. If a lamellar structure is desired, the solidification rate is preferably greater than 20 K/s. If a fibrous structure is desired, the rate is preferably less than 20 K/s, preferably less than 10 K/s, preferably less than 5 K/s.

In step c₂′″), demolding is preferably carried out before complete solidification of the block. Preferably, the block is demolded as soon as it has sufficient rigidity for substantially retaining its shape. The effect of contacting with the oxidizing or reducing fluid is then increased.

The first and second particular processes are industrial processes for manufacturing large amounts of product with good yields.

Of course, processes other than those described above could be envisaged for manufacturing a cermet precursor or a cermet product according to the invention.

A powder of a cermet product according to the invention may in particular be used to manufacture a porous product in accordance with the present disclosure, especially a porous anode functional layer, for example using a process comprising the following successive steps:
A) preparation of a powder of a cermet product according to the invention or a powder of a cermet product precursor according to the invention;
B) forming of the powder prepared in step A); and
C) sintering of said powder thus formed.

The cermet product powder used in step A) may especially be manufactured using steps a) to f) described above.

In step B), the powder may be deposited in the form of a layer.

In step C), the formed powder is sintered using conventional sintering techniques, preferably by hot pressing.

### EXAMPLES

The following nonlimiting examples are given for the purpose of illustrating the invention.

The products of examples 4, 6, 8, 10 and 12 were obtained by laser floating zone melting using a CO₂ laser of 600 watt power.

The raw materials used were the following:
a cobalt oxide CoO powder obtained from a cobalt oxide CO₃O₄ in the following manner: cobalt oxide CO₃O₄ sold by SIGMA-ALDRICH®, of around 99.7% purity, was calcined at 1000° C. for 4 hours in air in an alumina crucible. After holding at a temperature of 1000° C., the alumina crucible was removed from the furnace and placed on a water-cooled sheet of aluminum. The solidification rate was increased accordingly, thereby limiting any reoxidation of the CoO obtained to CO₃O₄. After complete cooling, the CoO content was checked by X-ray diffraction. A CoO content equal to or greater than 95% was expected, this measurement being carried out using the Rietveld method. The typical mass of CO₃O₄ treated during each calcination was 15 to 20 grams. After calcination, the cobalt oxide CoO powder was milled using zirconia balls having a diameter of 1 mm so as to reduce the median diameter to about 1 micron;

a cerium oxide CeO₂ powder sold by SIGMA-ALDRICH®, of around 99.9% purity, with a median diameter of less than 5 μm;

a nickel oxide NiO powder having a median diameter of about 1 μm, obtained by milling, in a Retsch MM 2000 ball mill using zirconia balls, a powder sold by SIGMA-ALDRICH®, of around 99.9% purity and with a median diameter of less than 5 μm; and

a powder of cerium oxide CeO₂ doped to 10 mol % with gadolinium (Gd₂O₃), Ce_{0.9}Gd_{0.1}O_{1.95}, prepared according to the following process: cerium nitrate in aqueous phase (Ce(NO₃)₃), sold by SIGMA-ALDRICH®, of around 99.5% purity, was mixed with gadolinium nitrate in aqueous phase (Gd(NO₃)₃.6H₂O), sold by SIGMA-ALDRICH®, of around 99.9% purity, in the presence of nitric acid (HNO₃) and ethylene glycol. The amounts of cerium nitrate and gadolinium nitrate were calculated so as to obtain, at the end of the preparation step, cerium oxide doped to 10 mol % with gadolinium oxide. The solution was heated between 80° C. and 90° C. so as to form a resin and then between 130° C. and 140° C. so as to cause an exothermic reaction enabling most of the organic elements to be eliminated. The residue obtained had the correct proportions of cerium oxide and gadolinium. The possible residual organic elements were eliminated by dispersing said residue in ethanol, which was then slowly evaporated at 100° C. The recovered residue was then sintered in air at 1350° C. with a temperature hold of 4 hours. The powder recovered after the heat treatment was a cerium oxide powder doped with 10 mol % gadolinium.

The powdered raw materials and their appropriate amounts were chosen according to the product to be manufactured. The raw materials were intimately blended manually in an agate mortar. During blending in the agate mortar, a 5% PVA/95% water solution was added in proportions of 1 ml per 1.5 to 2 g of powder blend. The mixture thus obtained was made in the form of rods by cold isostatic pressing (CIP) at 200 mbar for 3 to 4 minutes.

The rods obtained were then sintered in air in the following manner:
temperature rise from room temperature to 500° C. at 3° C./min;
temperature hold at 500° C. for 30 minutes;
temperature rise from 500° C. to 1350° C. at 3° C./min;
temperature hold at 1350° C. for 240 minutes; and
temperature fall to room temperature at 10° C./min.

The rods thus sintered were then moved translationally (no rotation of the rods) through the beam of a laser set at 60 W. They thus underwent laser floating zone melting with a constant growth rate of between 10 and 750 mm/h, corresponding to a solidification rate of between 2 and about 140 K/s. After directional solidification, the rod product was a fused cermet precursor according to the invention, the composition of which was adapted so as to result, by reduction, in a fused cermet product according to the invention.

The products of examples 3, 5, 7, 9, 11, 13 and 15 were obtained by reducing the products of examples 4, 6, 8, 10, 12, 14 and 16, respectively, using the protocol described below:

A quartz tube approximately 100 cm in length and with an inside diameter equal to 3 cm was inserted into a tubular furnace at rest. The quartz tube was longer than the furnace so as to allow it to move along the furnace according to the principle described in FIGS. 7A and 7B. A reducing gas mixture consisting of 5 vol % hydrogen (H₂) and 95 vol % argon (Ar) was made to flow through the quartz tube at a rate of 0.7 liters/minute so as to eliminate all traces of oxygen. The furnace was then heated to 750° C. (temperature rise of about 10° C./min). The preweighed rod was then inserted into the quartz tube (FIG. 7A) and the quartz tube was moved along the furnace so as to bring the rod to be treated into the hot zone of the furnace for 1 hour (FIG. 7B). The quartz tube was then moved so that the rod was outside the furnace. The rod was then extracted from the tube and weighed. The rod was then put back in the quartz tube and underwent a further heat treatment in the reducing gas mixture as described above until the weight of the rod no longer changed between two treatments.

The fused cermet precursors of examples 4, 6, 8, 10, 12, 14 and 16 resulted, at the end of this reduction treatment, in the fused cermets of examples 3, 5, 7, 9, 11, 13 and 15, respectively.

The product of comparative example 2 was obtained using the same process as described above for manufacturing the examples 4, 6, 8, 10, 12, 14 and 16 but without the floating zone melting step. This product was therefore not a fused product.

The product of comparative example 1 was obtained using the product of example 2, applying the reduction treatment described above.

In the various examples, the impurity contents were less than 2%.

The results are given in Table 1 below:

TABLE 1

| | | | | | | | | Fused cermet | |
|---|---|---|---|---|---|---|---|---|---|
| | | | mol % CeO₂ | | | mol % possibly | mol % possibly | precursor | |
| | | | doped to | | | doped | doped | manufacture | |
| | | mol % | 10 mol % | mol % | mol % | CeO2/mol % | CeO₂/mol % | solidification | |
| Example | Product | CeO₂ | of Gd | Co | Ni | Co | Ni | rate (K/s) | Structure |
| 1* | Gd₂O₃-doped CeO₂/Co cermet | | 18 | 82 | | | | — | non eutectic |
| 2* | Gd₂O₃-doped CeO₂/CoO cermet | | 18 | 82 | | | | — | non eutectic |
| | precursor | | | | | | | | |
| 3 | CeO₂/Co cermet | 18 | | 82 | | 0.219 | — | — | lamellar |
| 4 | CeO₂/CoO cermet precursor | 18 | | 82 | | 0.219 | | 140 | lamellar |
| 5 | CeO₂/Co cermet | 12.8 | | 87.2 | | 0.147 | | — | lamellar |
| 6 | CeO₂/CoO cermet precursor | 12.8 | | 87.2 | | 0.147 | | 140 | lamellar |
| 7 | CeO₂/Co cermet | 20.8 | | 79.2 | | 0.263 | | — | lamellar |
| 8 | CeO₂/CoO cermet precursor | 20.8 | | 79.2 | | 0.263 | | 140 | lamellar |
| 9 | Gd₂O₃-doped CeO₂/Co cermet | | 18 | 82 | | 0.219 | | — | lamellar |
| 10 | Gd₂O₃-doped CeO₂/CoO cermet | | 18 | 82 | | 0.219 | | 140 | lamellar |
| | precursor | | | | | | | | |
| 11 | CeO₂/Ni cermet | 30 | | | 70 | | 0.429 | — | lamellar |
| 12 | CeO₂/NiO cermet precursor | 30 | | | 70 | | 0.429 | 10 | lamellar |
| 13 | CeO₂/Co cermet | 18 | | 82 | | 0.219 | | — | fibrous |
| 14 | CeO₂/CoO cermet precursor | 18 | | 82 | | 0.219 | | 2 | fibrous |
| 15 | Gd₂O₃-doped CeO₂/Co cermet | | 18 | 82 | | 0.219 | | — | fibrous |
| 16 | Gd₂O₃-doped CeO₂/CoO cermet | | 18 | 82 | | 0.219 | | 2 | fibrous |
| | precursor | | | | | | | | |

*comparative examples

Porosity Stability Measurement

Five specimens were taken randomly from each rod of comparative example 1 and example 9 of the present disclosure.

Each rod then underwent the following aging treatment: a quartz tube approximately 100 cm in length and with an inside diameter equal to 3 cm was inserted into a tubular furnace at rest. The quartz tube was longer than the furnace so as to allow the tube to move in the furnace, according to the principle illustrated in FIGS. 7A and 7B. A reducing gas mixture consisting of 5 vol % hydrogen (H₂) and 95 vol % argon (Ar) was made to flow through the quartz tube at a flow rate of 0.4 liters/minute so as to eliminate all traces of oxygen. The furnace was then heated to 750° C. (temperature rise of about 10° C./min). The rod was then inserted into the quartz tube and the quartz tube was moved along the furnace so as to bring the rod to be treated into the hot zone of the furnace for 306 hours. The quartz tube was then moved so that the rod was outside the furnace, the rod then being extracted from the tube so as to be analyzed.

Five other specimens were then taken at random from the rod obtained so as to be compared with the specimens from the same rod that were taken before the aging treatment.

For this purpose, the specimens before aging treatment and after aging treatment were embedded in a resin and polished. Each polished section was then observed under a scanning electron microscope (SEM). One micrograph per section was taken.

Each micrograph was then processed using the DIGITALMICROGRAPH™ program (version 3.10, sold by Gatan Software) so as to be converted into pixels. The pores were then isolated by their color, and the area of each pore calculated taking the magnification of the micrograph into account. For each rod, a number distribution of pores as a function of their area, before and after the aging treatment, was determined. These distributions were evaluated accumulatively on the five micrographs of the five specimens taken from this rod, before and after the aging treatment respectively. For example, the number distribution of the pores as a function of their area before the aging treatment of the rod of comparative example 1 was the sum of the distribution of the pores measured on each of the five micrographs (one per specimen) taken on the five specimens taken from this rod before the aging treatment.

By definition of the percentiles, 99% of the pores by number had a pore size below the 99 percentile, or D₉₉.

Likewise, 90% of the pores by number had a pore size of less than 90 percentile, or D₉₀.

The percentage increase in the percentile Dᵢ was defined by the following formula:

[(Dᵢ after aging treatment)−(Dᵢ before aging treatment)]/(Dᵢ before aging treatment),

Tables 2 and 3 below summarize the results obtained.

TABLE 2

| | D₉₉ before | D₉₉ after | |
|---|---|---|---|
| | aging | aging | % |
| | treatment | treatment | increase |
| | (μm) | (μm) | in D₉₉ |
| Comparative example 1 | 2.55 | 5.08 | 99.2 |
| Example 9 | 1.30 | 1.40 | 7.7 |

TABLE 3

| | D₉₀ before | D₉₀ after | |
|---|---|---|---|
| | aging | aging | % |
| | treatment | treatment | increase |
| | (μm) | (μm) | in D₉₀ |
| Comparative example 1 | 0.89 | 1.08 | 21.3 |
| Example 9 | 0.46 | 0.51 | 10.8 |

The measurements show a markedly smaller change in porosity in the example of the present disclosure than in the comparative example.

Surprisingly, the inventors have therefore demonstrated that a product of the present disclosure exhibits greater porosity stability over time.

The present disclosure thus also relates to the use of a cermet product according to the invention for increasing the stability of the porosity over time.

As is now clearly apparent, the invention provides a novel porous product:
offering regions of contact between the anode material, the electrolyte and the fuel (“triple points” or “TPBs” (triple phase boundaries)) that are long and numerous;
substantially maintaining its level of porosity over time;
being chemically resistant, over time, under the service conditions; and
being mechanically resistant, over time, especially for withstanding the forming operation and the thermal cycles in service.

Of course, the present invention is not limited to the embodiments described, these being provided merely for illustration.

Moreover, a product according to the invention may comprise regions having different chemical compositions (but within the range of compositions claimed) and/or different structures (for example regions having a lamellar structure and regions having a lamellar and fibrous structure).

1. A fused cermet product comprising a fused cermet based on doped cerium oxide CeO₂, nickel Ni and/or cobalt Co, said cermet having a eutectic structure and the percentage molar contents of cerium oxide CeO₂, nickel and cobalt are represented by:
0.351 Ni+0.136 Co≦(CeO₂+dopant)≦0.538 Ni+0.282 Co.

2. The product according to claim 1, wherein said fused cermet is more than 50% of its mass.

3. The product according to claim 2, wherein said fused cermet is more than 90% of its mass.

4. The product according to claim 1, wherein the cermet does not contain nickel and is for a total, excluding impurities, of 100%:
(CeO₂+dopant): 12%-22%
Co: 78%-88%.

5. The product according to claim 1, wherein the cermet does not contain cobalt and is for a total, excluding impurities, of 100%:
(CeO₂+dopant): 26%-35%
Ni: 65%-74%.

6. The product according to claim 1, wherein the cerium oxide CeO₂ is doped with an element selected from the group consisting of lanthanides, with the exception of cerium, and mixtures thereof, yttrium, magnesium, calcium, strontium and barium.

7. The product according to claim 6, wherein cerium oxide CeO₂ is doped with samarium and/or gadolinium.

8. The product according to claim 1, wherein the cerium oxide CeO₂ is not doped.

9. The product according to claim 1, wherein the cerium oxide CeO₂ is doped with an element selected from lanthanides, with the exception of cerium and samarium.

10. The product according to claim 1, wherein the dopant molar content of the cerium oxide CeO₂, on the basis of the sum of the molar contents of cerium cations and dopant cations, is greater than 8% and less than 25%.

11. The product according to claim 1, wherein:
the cerium oxide CeO₂ is doped only with samarium, the molar content of samarium cations, on the basis of the sum of the molar contents of cerium cations and samarium cations, being greater than 16% and less than 24%; or
the cerium oxide CeO₂ is doped only with gadolinium, the molar content of gadolinium cations, on the basis of the sum of the molar contents of cerium cations and gadolinium cations, being greater than 8% and less than 14%.

12. The product according to claim 1, wherein the product has a lamellar mean spacing between two lamellae being greater than 0.2 μm and less than 6 μm, and/or a fibrous structure.

13. The product according to claim 1, wherein a balance to 100% consists of impurities and nickel oxide and/or cobalt oxide.

14. An electrode comprising a region formed from a powder of particles made of a fused cermet product according to claim 1.

15. A fused cermet precursor, the composition of which is adapted so as to result, by reduction, in a cermet product according to claim 1, with the exclusion of a CeO₂/CoO cermet precursor having an irregular structure.

16. A manufacturing process comprising the following successive steps:
a) mixing particulate raw materials including CeO₂, CoO and/or NiO, and/or one or more of the precursors of these oxides, and/or optionally one or more dopants for cerium oxide, and/or one or more precursors of these dopants, to form a feedstock;
b) melting the feedstock so as to obtain a molten material;
c) cooling said molten material until it has completely solidified so as to obtain a fused product having a eutectic structure;
d) optionally, said fused product is milled;
e) optionally, the fused product, possibly milled, is formed or even sintered;
f) optionally, the fused product, possibly milled and/or formed and/or sintered, is reduced so as to increase the amount of CoO and/or NiO converted to Co and/or Ni,
the raw materials being chosen so that, after step c), the fused product obtained is a fused cermet product according to claim 1 and the cooling in step c) consists of bringing the molten material being cooled and/or the fused product into contact with a reducing fluid.

17. The process according to claim 16, but not including step f).

18. The process according to claim 16, wherein a furnace, chosen from an induction furnace, a plasma torch, an arc furnace or a laser, is used in step b).

19. The process according to claim 16, wherein the reduction in step f) takes place simultaneously with sintering.

20. The process according to claim 16, wherein the solidification rate in step c) is greater than 1 K/s.

21. The process according to claim 16, wherein the solidification rate in step c) is greater than 20 K/s or less than 10 K/s.

22. The process according to claim 21, in which the solidification rate in step c) is less than 5 K/s.
